(19) United States
(12) Patent Application Publication
(10) Pub. No.: US 2023/0171695 A1
(43) Pub. Date: Jun. 1, 2023

(54) METHODS FOR POWER MANAGEMENT IN A WIRELESS COMMUNICATIONS NETWORK, NETWORK NODES AND WIRELESS DEVICES

(71) Applicant: Sony Group Corporation, Tokyo (JP)

(72) Inventors: Anders BERGGREN, Lund (SE); Basuki PRIYANTO, Lund (SE); Nafiseh MAZLOUM, Lund (SE); Torgny PALENIUS, Barsebäck (SE)

(21) Appl. No.: 17/912,080

(22) PCT Filed: Mar. 19, 2021
(86) PCT No.: PCT/EP2021/057115

§ 371 Date: Sep. 16, 2022

(30) Foreign Application Priority Data
Mar. 20, 2020 (SE) 2050310-8

(51) Int. Cl. H04W 52/02; H04W 68/02

(52) U.S. Cl. CPC H04W 52/0219; H04W 68/02

(57) ABSTRACT

A method is disclosed, performed in a radio network node, for power management in a wireless communications network. The radio network node is transmitting reference signals to WDs in conjunction with a first set of paging resources that the WDs are monitoring for paging. The method comprises: upon determining that a radio network node power save mode is to be activated, transmitting, to the WDs, an indication instructing the WDs to monitor paging in a second set of paging resources associated with the radio network node power save mode. The method further comprises transmitting, to the WDs, synchronization signals associated with the second set of paging resources that the WDs are instructed to monitor for paging.

The present disclosure pertains to the field of wireless communications. The present disclosure relates to methods for power management in a wireless communications network, related radio network nodes and related wireless devices.

### BACKGROUND

In today's wireless communications networks, the power consumption of the radio network nodes is rather high, and it is necessary to reduce the power consumption in a radio network node, such as a base station, such as an evolve NodeB (eNB) or New Radio (NR) base station (which may be referred to as gNB).

It is noted that a radio network node is to be continuously active, transmitting the reference signals periodically in order to serve wireless devices in the area, paging transmission and also be available for random access attempts.

A wireless device (WD) moving in a wireless communications network may find a suitable cell to camp on. It may then perform measurements (such as mobility measurements) on a serving cell and on neighboring cells. Based on the measurements, the wireless device may change to another cell having better measurement results than the serving cell, such as may attempt to camp on the best cell based on these measurements. The measurements are performed on the reference signals transmitted from the radio network node.

The reference signals are used to support the wireless devices camping on the cell with good synchronization to the radio network node and possibility to access the radio network node, and to monitor for downlink paging indication. The downlink paging indication is transmitted in a control channel (Physical Downlink Control Channel, PDCCH). If there is a paging indication then the wireless device continues to receive the paging message in a shared channel (Physical Downlink Shared Channel, PDSCH). The reference signals are, e.g., synchronization signals in the Synchronization Signal Blocks (SSBs), which are used to detect cells. A wireless device that is switched on, or exits flight mode, attempts to find carriers where there are synchronization signals available. These synchronization signals are used for initial cell search to detect the cells on which it can access the network.

These activities lead to energy consumption by the radio network node.

### SUMMARY

It is an object of this disclosure to reduce the energy consumption of the radio network node. This is done by letting the radio network node enter a power save mode, which is a state where the radio network node consumes less energy. A power save mode is typically used when the activity in a cell of the radio network node is lower than normal (such as when the activity is lower than an activity threshold). Reducing the energy consumption of the radio network node can for example be done by reducing a transmission density in time/frequency whenever it is appropriate. This may also lead to reducing the interference to other cells.

For a NR cell with default Synchronization Signal Block (SSB) periodicity of e.g., 20 ms and 15 kHz subcarrier spacing, the duty cycle to transmit two sets of these symbols carrying SSB is estimated to be around 2-2.5%. Paging resources for a plurality of WD paging groups are during normal operation evenly distributed over time. Such normal operation is useful during or high activity periods, such as when the activity in a cell is equal to or above the activity threshold. In order to ensure that the WDs can perform measurements on and synchronize to the radio network node prior to their respective paging resources, the radio network node transmits SSBs with a default periodicity in the cells during normal operation. The SSBs are then transmitted with a default periodicity in order to allow WDs to continuously stay in sync, for example to enable the UEs to measure and synchronize to the radio network node prior to monitoring a paging resource of the WDs, independently of where the paging resource is located in time. The duty cycle of the complete radio network node due to this activity may however be higher since the radio network node is prepared to receive Random Access Channel (RACH) attempts and transmit subsequent RACH message(s), transmit paging for a plurality of wireless devices (such as User Equipment (UEs)) in idle mode, etc. in addition to the transmission of SSBs. Given that for many cells there are during e.g. nights very low or no activity, the continuous power consumption for transmitting the SSBs and paging are still very or relatively high.

The appropriate time for reducing power consumption of radio network nodes may be for example during night and other periods with low activity. In such case, many (e.g., all) the WDs are mainly in idle mode (especially in cells where there are very few wireless devices camping during these low activity periods). In the low activity periods, the number of WDs being paged may be low. This disclosure is based on the insight that it would then be possible to allow the radio network node to group paging occasions for all of the WDs in the cell into one or more common paging resource, such as to a number of paging resources, or paging occasion, in paging frames that are grouped together (such as in subsequent paging frames). By grouping the paging occasions for the WDs into the common paging resource, the WDs may only require the reference signals to be transmitted in the vicinity in time of the common paging resource in order to synchronize with the radio network node prior to the paging occasion. Being transmitted in the vicinity in time may herein mean that the reference signals are scheduled in resources close to the common paging resource. The radio network node may thus refrain from transmitting reference signals, such as reference signals comprised in the SSBs, with the default periodicity. Instead, the radio network node may only transmit reference signals in the vicinity of the common paging resource, which allows the radio network node to reduce its transmissions and stay in an inactive state for longer periods of time. Thereby the energy consumption of the radio network node may be reduced.

Accordingly, there is a need for devices (such as a wireless device and a radio network node) and methods, for power management in a wireless communications network, which mitigate, alleviate or address the existing shortcomings and provide a more power efficient network.

A method is disclosed, performed in a radio network node, for power management in a wireless communications network. The radio network node is transmitting reference signals to WDs in conjunction with a first set of paging resources that the WDs are monitoring for paging. The method comprises: upon determining that a radio network node power save mode is to be activated, transmitting, to the WDs, an indication instructing the WDs to monitor paging in a second set of paging resources associated with the radio network node power save mode. The method further comprises transmitting, to the WDs, reference signals associated with the second set of paging resources that the WDs are instructed to monitor for paging.

Further, a radio network node is provided, the radio network node comprising a memory circuitry, a processor circuitry, and a wireless interface. The radio network node is configured to transmit reference signals to WDs in conjunction with a first set of paging resources that the WDs are monitoring for paging. The radio network node is configured to, upon determining that a radio network node power save mode is to be activated, transmitting, to the WDs, an indication instructing the WDs to monitor paging in a second set of paging resources associated with the radio network node power save mode. The radio network node is configured to transmit, to the WDs, reference signals associated with the second set of paging resources that the WDs are instructed to monitor for paging.

The disclosed radio network node and related method to enable a reduction of the power consumption of the radio network node while allowing paging in an efficient manner that is aligned with WDs served.

Further, a method is disclosed, performed in a Wireless Device (WD), for power management in a wireless communications network. The WD is comprised in a set of WDs associated to a cell of a radio network node. The WD initially monitors paging signals at a first set of paging resources. The method comprises receiving, from the radio network node, an indication instructing the WD to monitor paging signals at a second set of paging resources associated with a network node power save mode. The method comprises monitoring paging signals in the second set of paging resources.

Further, a WD is provided, the WD comprising a memory circuitry, a processor circuitry, and a wireless interface. The WD is comprised in a set of WDs associated to a cell of a radio network node. The WD is configured to listen for paging signals at a first set of paging resources. The WD is configured to receive, from the radio network node, an indication instructing the WD to monitor paging signals at a second set of paging resources associated with a radio network node power save mode. The WD is further is configured to monitor paging signals in the second set of paging resources.

It is an advantage of the present disclosure that paging resources and synchronization signal transmission for WDs associated with the network node can be grouped such that the radio network node is capable of optimizing the periods for entering a power save mode.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 is a diagram illustrating an exemplary wireless communication system comprising an exemplary network node and an exemplary wireless device according to this disclosure,

FIG. 2 is a diagram illustrating paging frame and paging occasions,

FIG. 3 is a diagram illustrating a paging time window in eDRX,

FIG. 4 is a diagram illustrating a radio network node transmission profile for paging transmission for multiple UEs,

FIG. 5 is a diagram illustrating grouping of paging frames in a time domain according to this disclosure,

FIG. 6 is a diagram illustrating grouping of paging frames in a frequency domain according to this disclosure,

FIG. 7 is a diagram illustrating grouping of paging frame in low activity mode according to this disclosure,

FIG. 8 is a diagram illustrating a known transmission of synchronization signal block bursts,

FIG. 9 is a diagram illustrating transmission of synchronization signal block bursts according to this disclosure,

FIG. 10 is a diagram illustrating cell planning of cells in low activity mode and normal mode,

FIG. 11 is a flow-chart illustrating an exemplary method, performed in a radio network node, for power management in a wireless communications network according to this disclosure,

FIG. 12 is a flow-chart illustrating an exemplary method, performed in a wireless device, for power management in a wireless communications network according to this disclosure,

FIG. 13 is a block diagram illustrating an exemplary radio network node according to this disclosure, and

FIG. 14 is a block diagram illustrating an exemplary wireless device according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

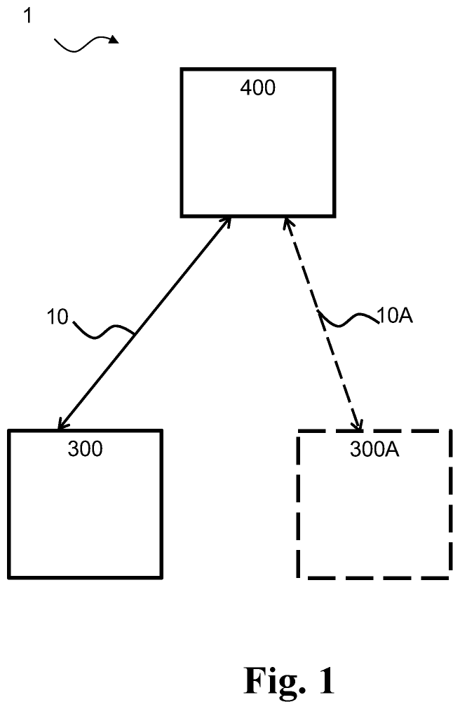

FIG. 1 is a diagram illustrating an exemplary wireless communication system 1 comprising an exemplary radio network node 400 and an exemplary wireless device 300 according to this disclosure.

As discussed in detail herein, the present disclosure relates to a wireless communication system 1 comprising a cellular system, e.g., a 3^{rd} Generation Partnership Project (3GPP) wireless communication system. The wireless communication system 1 comprises the wireless device 300 and/or the radio network node 400.

The radio network node disclosed herein refers to a radio access network node operating in the radio access network, such as a base station, an evolved Node B (eNB), a gNB or an access point.

The wireless communication system 1 described herein may comprise one or more wireless devices 300, 300A, and/or one or more radio network nodes 400, such as one or more of: a base station, an eNB, a gNB and/or an access point.

A wireless device may refer to a mobile device and/or a user equipment (UE).

The wireless device 300, 300A may be configured to communicate with the radio network node 400 via a wireless link (or radio access link) 10, 10A.

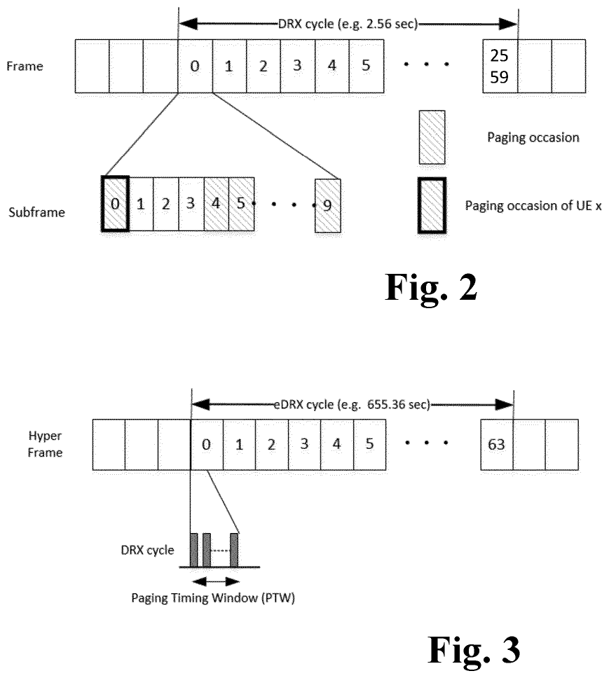

FIG. 2 is an illustration of paging frames and paging occasions in 3GPP Long Term Evolution (LTE) and NR. During idle mode, a paging indication is transmitted in each Discontinuous Reception (DRX) cycle as illustrated in FIG. 2. In this example, the DRX cycle can be up to 2.56 sec. In reality a network may configure several DRX cycles for numerous UEs. Within a paging frame, there can be multiple paging occasions and the network can assign a unique paging occasion within a paging frame to a WD, such as to a UE x. The legacy specifications 3GPP TS 36.304 v15.5.0 and TS 38.304 v15.6.0 defines the formula of paging frame and paging occasion. The referred equations are also given in the appendix.

In LTE and NR system frames and subframes have been defined, which are used for timing synchronization of the WD and the radio network node. Each system frame has a time duration of 10 ms and may be identified by a number referred to as System Frame Number (SFN) between 0 and 1023. Each system frame comprises 10 subframes, each subframe having a time duration of 1 ms. The subframes in a system frame may be identified by a subframe number from 0 and 9. During cell search and timing synch the radio network node and WD may synchronize their SFN and subframe counters. When the subframe number reaches the maximum value (such as 9), the subframe counter goes back to 0 and the SFN counter increases by 1. When the SFN counter reaches the max value (such as 1023), the SFN counter goes back to 0. During a communication period the WD and the radio network node maintain synchronization based on subframe number and SFN.

Based on Subframe and SFN definition, the longest time span for the timing synchronization without resetting to 0 is 1023 SFN. This corresponds to 1024 system frames×10 ms, which is 10.24 sec. Most timing related parameters (such as Idle mode DRX or Connected Mode DRX) may be configured within this max timing value.

A further timer has been introduced in LTE-MTC and NB-IoT referred to as Hyper Frame Number or Hyper SFN (HFN). HFN is a timer at a higher level to SFN. HFN ranges between 0 and 1023 and the value increases by 1 when SFN reaches 1023 and then the SFN counter resets to 0.

With this longer time span and in order to conserve WD energy, LTE-MTC and Narrowband-IoT (NB-IoT) type WDs, may be assigned to be operated with longer sleep time-period than the one in DRX. This new setup may be referred to as extended DRX (eDRX). Similar configuration and/or set-up may also be introduced in future NR releases. A timing diagram for eDRX is illustrated in FIG. 3. In this example the eDRX cycle may be 64 hyperframes. The wireless communications network may assign different eDRX cycles for other WDs. In the start of eDRX, it may contain multiple DRX cycles within a paging timing window (PTW).

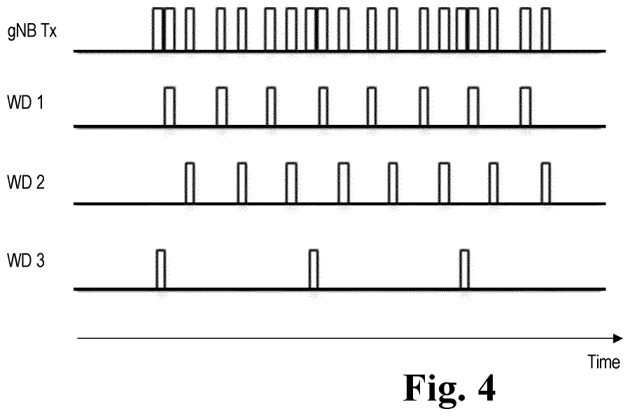

Since each WD may have its own DRX and/or eDRX cycle, the radio network node (such as the eNB or gNB) may transmit paging indication frequently, even in an off-peak period, such as a period with low activity in a cell, as shown in FIG. 4. FIG. 4 shows the distribution of paging frames over time for three different WDs and the corresponding paging signal transmit (Tx) frames for the radio network node, in FIG. 4 referred to as gNB Tx, for a legacy configuration, such as without grouping of paging frames. Each box in FIG. 4 indicates a paging frame and/or a paging occasion. As can be seen, the paging frames and/or occasions for the WDs are distributed in time and the WDs may have different DRX cycles. WD1 and WD2 have equally long DRX cycles which are offset in time, while WD3 has a longer DRX cycle than WD1 and WD2. Since the radio network node, such as the gNB, transmits paging signals to all of the three WDs shown in FIG. 4, the radio network node has to be active during all of the paging frames for WD1, WD2 and WD3. Thus, the radio network node can only be inactive during short periods of time between paging frames for the three WDs.

This may not be efficient in term of network power consumption. Moreover, during an off-peak period the WD may not have any paging messages at all. Hence, the current disclosure provides a method for reducing network power consumption by grouping the paging occasions for the WDs.

According to one or more of the embodiments disclosed herein, the paging occasions (PO) and/or paging frames (PF) for one or more WDs associated with a cell of the radio network node may be grouped. Furthermore, the radio network node may refrain from transmitting SSBs with reference and/or synchronization signals, and/or broadcasted transmissions, that are not associated with the grouped paging occasions and/or paging frames, such as not associated with the second set of paging resources. Thereby, a discontinuous transmission (DTX) opportunity of the radio network node may be increased. In other words, the time duration during which the radio network node does not have to transmit, and thus can be inactive to save power, may be increased. This procedure is illustrated in the following example:

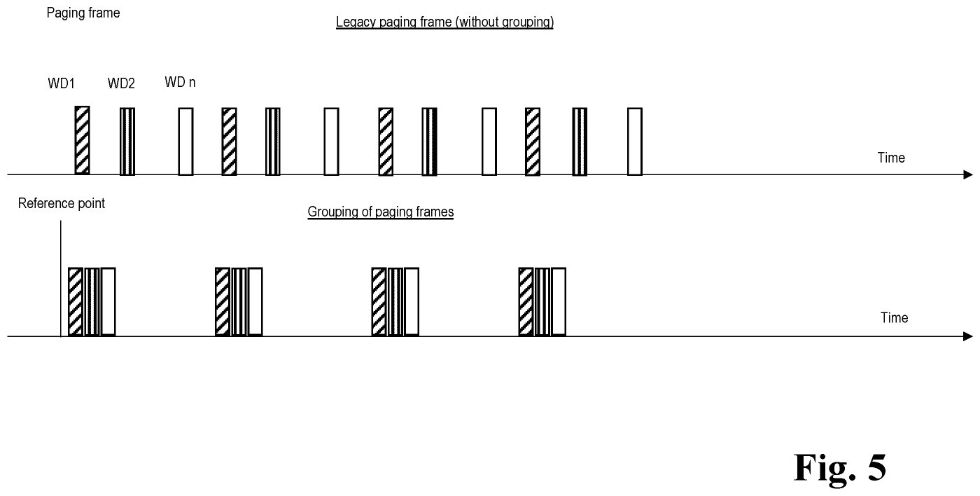

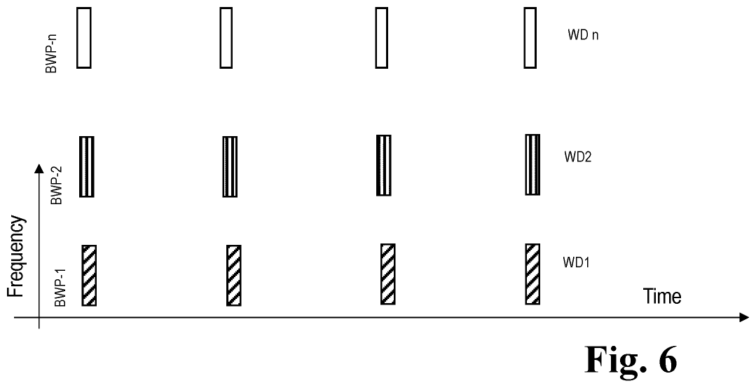

The radio network node may inform the WD that the radio network node intends to perform a power save operation (such as due to an off-peak time, such as during nighttime). During the off-peak time an activity in a cell of the radio network node may be low, such as below an activity threshold. The radio network node may inform the WD by transmitting an off-peak or power save mode operation flag in a system information. The operation flag may e.g., be broadcasted to all WDs in the cell.
1. The grouping of paging occasion and/or paging frame may be done by grouping of paging occasions of multiple WDs associated with a cell of the radio network node, within a certain period of time to a reference time and/or to a reference signal transmission, as shown in FIG. 5.
   a. The reference time may be a frame number, such as an SFN, and/or a hyper frame number. In this case, some or all WDs may have the paging indication in the same paging frame and/or in contiguous paging frames.
   b. The reference signal transmission may be the reference signals that are transmitted, such as in the SSB transmission or in other reference signals (such as Channel State Information Reference Signals (CSI-RS), Tracking reference Signals (TRS), etc.).
2. The grouping of paging frames and/or paging occasions may also be done for multiple Bandwidth parts (BWPs), such as for different frequencies or frequency bands, by keeping the paging indication and paging messages in different BWPs aligned in time as disclosed in FIG. 6. When the radio network node transmits paging signals in a plurality of BWPs, the paging frames and/or paging occasions for each the plurality of BWPs may be aligned in time.
3. The radio network node may configure the WD on the grouping methods during off-peak, such as during low activity periods. This may e.g., be done by Radio Resource Control (RRC) configuration.

By grouping the paging occasions for the WDs, the WDs that are in idle mode (DRX) are to be paged during the same or adjacent paging occasions and/or paging frames. The WD synchronizes to the radio network node during a time period in advance of the paging frame. Hence, the DRX paging cycles of the WDs in the cell may be grouped, thereby allowing the radio network node to be inactive for longer times between the paging occasions and/or paging frames.

For eDRX, where the WDs camping in the cell are configured with eDRX, such as Cellular IoT (CIoT) devices, the eDRX PTW cycle may be grouped in a similar way, allowing the radio network node, to be inactive for longer times between the PTWs. The paging frames and paging occasions may be aligned within the PTW if there is a low probability for paging, or the PTWs may be aligned without aligning the paging frames if needed.

Paging events, such as paging occasions or paging frames, for a WD in DRX mode may be derived by a WD identifier (WD ID), such as the parameter UE_ID, which is based on a Serving Temporary Mobile Subscriber Identity (S-TMSI) or a 5G-S-TMSI of each WD, which may also be referred to as a legacy UE ID. The grouping of the paging events may be based on that the PF and POs are configured so that all WDs camping on a cell of the radio network node are aligned to the same or a few consecutive frames. This may be achieved either by:
Option 1: The WDs may be provided with alternative WD IDs (which may also be referred to as temporary WD IDs, such as UE_IDs, which configures the WDs to read paging at these aligned PFs and POs, or
Option 2: The WDs keep their configured legacy UE_IDs and change an equation used for determining, such as calculating, the PF and the PO.

The PF and the PO may be given by the equations below.

The SFN in which the PF is located may be determined, based on the UE ID, with the following equation (1):

SFN mod T=(T div N)*(UE_ID mod N) (1)
where T is the periodicity of the paging signals

An index i_s pointing to the PO may be derived from the following equation (2):

i_s=floor(UE_ID/N)mod Ns (2)

In the first option, the WDs may determine the paging frame and the paging occasion with equations (1) and (2) based on an alternative WD identifier, such as an alternative UE_ID. The WDs may be configured with the alternative UE_IDs, either by a broadcasted message or by dedicated signaling from the radio network node, when the radio network node and/or the cell enters a power save mode. The power save mode is a mode in which the radio network node consumes less power in comparison to a normal mode. In the power save mode the radio network node may reduce its energy consumption for example by reducing the density of transmissions from the radio network node in time or frequency. Thereby, the hardware may be set in a power save state, at times when there are no transmissions. The power save mode may e.g. be entered during low activity periods when an activity in the cell is below the activity threshold. The activity threshold may e.g., be a predetermined number of WDs in connected mode in the cell or a predetermined number of pagings that are transmitted in the cell. The number of pagings that are transmitted in the cell may be determined retroactively, such as how many paging messages that have been transmitted during a previous time, such as during the last hour. In one or more exemplary methods, the low activity period may be determined based on history (such as historical paging data), such as how many paging messages that normally is transmitted e.g., during specific low traffic hours. In a similar way the radio network node may configure the WDs to use the legacy UE_ID of the WD (based on the S-TMSI of the WD) when the radio network node deactivates the power save mode, such as during normal or high activity periods.

In the second option, the equations (1) above for determining the PF may be changed, so that only a few frames, which may be referred to as PF_{lowactivity}, may be used by all WDs every DRX cycle. These frames may be determined by taking the equation modulo N_{low activity}, where N_{low activity} may be between 1 and T, thus limiting the PF for all WDs to be in N_{low activity} frames only out of the T possible frames.

Thus, the equation used in the second option for grouping the paging events becomes:

SFN mod T=((T div N)*(UE_ID mod N))mod N_{low activity} (3)

Regardless of the option used, the paging frames will be grouped to a few defined frames, where (SFN mod T)=0, 1, . . . (N_{low activity}−1), in which all WDs camping on the cell are paged.

The radio network node may send a signal to the WDs indicating that the radio network node power save mode is inactivated. When the radio network node power save mode is inactivated the radio network node is not operating in the power save mode. In the power save mode the radio network node consumes less power in comparison to a normal mode. Hence, when the power save mode is inactivated the radio network node returns to a normal mode in which the radio network node handles a higher activity in the cell and thus consumes more power than in the power save mode. The radio network node power save mode may also be referred to as the low activity mode. The radio network node inactivating the power save mode may also be referred to as the radio network node entering normal or legacy operation, which may also be referred to as normal or legacy mode. The radio network node may exit the power save mode e.g., when the activity in a cell of the radio network node is above an activity threshold or when entering a time for normal activity hours, such as hours in which the activity typically increases. The threshold may e.g., be a predetermined number of WDs in connected mode in the cell or a predetermined number of pagings that have to be sent in the cell. When the radio network node has inactivated the power save mode, the WDs are to return to their normal, such as legacy, paging frames and paging occasions. This may e.g. be done by using the legacy UE_ID and/or legacy equations, such as the equations (1) and (2) above, to calculate the timing of the paging for the first set of paging resources.

FIG. 5 shows grouping of paging frames and/or paging occasions in time according to one or more exemplary methods of the current disclosure. The grouping of paging occasions and/or paging frames may be done for multiple WDs associated with a cell of the radio network node, within a certain period of time from a reference time and/or from a reference signal transmission. Associated with a cell of the radio network node, may herein be interpreted as WDs that have context with the cell of the radio network node, such as a UE context. In the upper figure of FIG. 5, legacy paging frames without grouping for a plurality of WDs, such as WD paging groups is shown, in this case WD1, WD2 and WDn. WD1, WD2 to WDn may herein represent respective WD paging groups comprising one or more WDs. The paging frames for the plurality of WDs are distributed in time. The lower figure of FIG. 5 discloses a grouping of the paging frames for the plurality of WDs of the upper figure of FIG. 5. As can be seen, the paging frames for the WDs are located adjacent to each other in time, such as in adjacent resources in time, such as adjacent system frames, subframes or slots. Thereby, the paging frames for the plurality of WDs and/or WD paging groups, in this case WD1, WD2 to WDn, can be grouped closer together in time, while still being distributed in time and/or frequency, to enable at least a first WD and/or WD paging group and a second WD and/or WD paging group to be separately paged.

FIG. 6 shows a grouping of paging frames and/or paging occasions in time for multiple BWPs, such as for different frequencies or frequency bands, according to one or more exemplary methods of the current disclosure. As can be seen in FIG. 6, the paging frames and/or paging occasions of WD1, WD2 and WDn may be aligned in time but transmitted in different BWPs. FIG. 6 discloses four paging occasions for each of the three WDs. The paging frames and/or paging occasions for the three WDs have been grouped in the same resource in time, such as in adjacent system frames, subframes, slots and/or symbols. However, in comparison to the exemplary embodiment shown in FIG. 5, the paging frames and/or paging occasions for the three WDs have been separated in frequency, such that the paging frames and/or paging occasions for WD1 are located in a BWP-1, the paging frames and/or paging occasions for WD2 are located in a BWP-2 different from BWP-1, and the paging frames and/or paging occasions for WDn are located in a BWP-n different from BWP-1 and BWP-2. By separating the paging frames and/or paging occasions for each of the WDs into separate BWPs, the paging frames and/or paging occasions for the multiple WDs may be moved closer in time, such as transmitted in the same subframe, slot and/or symbol, which may further increase a duration during which the radio network node may stay inactive.

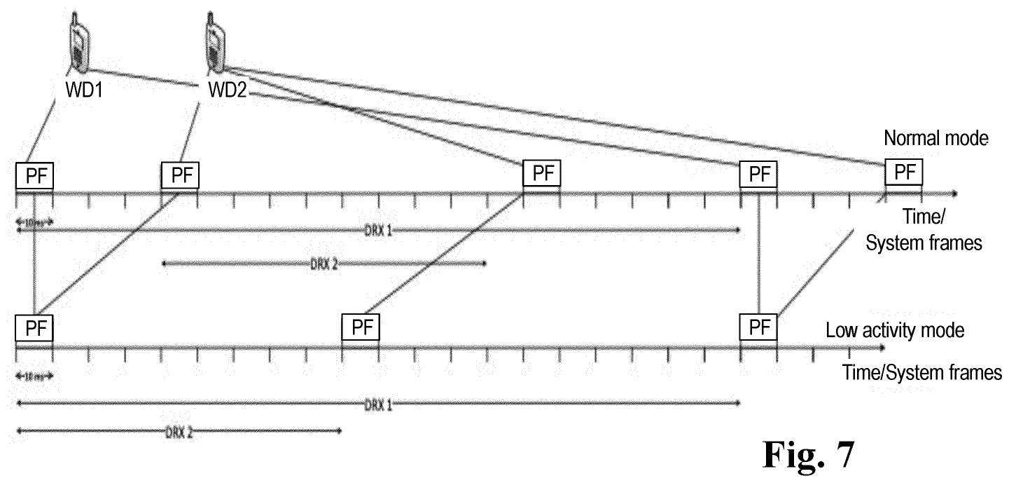

FIG. 7 shows the paging resources, such as paging frames, for a first and a second WD, WD1 and WD2, having different DRX cycles both in Normal Mode and in the radio network node power save mode, which may also be referred to as the low activity mode.

As can be seen, the WD1 is configured with a first DRX cycle DRX1, which first DRX cycle is longer than a second DRX cycle DRX2 for the WD2. In the Normal mode the timing of the paging frames for DRX1 and DRX 2 is distributed over time. The paging frames being distributed over time may herein be interpreted as the DRX cycles having the first paging frames in different system frames. In other words, the DRX cycles, such as the DRX cycles DRX1 and DRX2, may be offset in time. The DRX cycles being offset in time may herein mean that the first paging frame of each DRX cycle are offset in time from each other. In the low activity mode, the timing of the paging frames for the first and second WD may be aligned (which may also be referred to as being grouped) while still keeping the individual DRX cycles, DRX1 and DRX2. As can be seen in FIG. 7, the paging frames of WD1 may remain in their original position during the low activity mode, while the paging frames of WD2, such as at least one of the paging frames of WD2, have been aligned (which may also be referred to as being grouped) with the paging frames of WD1, such that the DRX cycles of WD1 and WD2 are no longer offset in time. It shall be noted that the WD1 and WD2 in FIG. 7 may represent respective paging groups comprising a plurality of WDs, wherein the WDs comprised in each paging group share the same paging resources. In other words, the plurality of WDs comprised in the paging group comprising WD1 may all be paged in the paging frames of WD1. Similarly, the plurality of WDs comprised in the paging group comprising WD2 may all be paged in the paging frames of WD2.

For the eDRX cycle the PTW may be based on another parameter UE_ID_H, which may also be based on the S-TMSI/5G-S-TMSI and with a similar equation as for the DRX cycle. The UE_ID_H may comprise the 10 most significant bits of a Hashed ID, if P-RNTI is monitored on PDCCH or Machine-Type Communication Physical Control Channel (MPDCCH) and the 12 most significant bits of the Hashed ID, if P-RNTI is monitored on NB-IoT Physical Control Channel (NPDCCH). The Hashed ID may be a Frame Check Sequence (FCS) for the bits b31, b30 . . . , b0 of S-TMSI. This scheduling may thus be aligned in a similar way as described for the DRX cycle above.

For mobility purposes, neighbor cell measurements performed by a WD are typically performed in connection with paging occasions when the WD is awake. However, according to this disclosure, one or more neighbor cells may be configured to be in low activity mode. Therefore, with an SFN synchronized wireless communications network where the paging frames of all the WDs camping in the neighbor cells are grouped (which may also be referred to as aligned), such that they are equal or adjacent to each other, only reference signals, such as synchronization signals, associated with the grouped paging frames may be used for measurements for the WDs in the same cell as well as for WDs in other neighbor cells. Reference signals associated with the grouped paging frames may be reference signals being transmitted close to the grouped paging frames, and/or being required by the WD for synchronizing to the radio network node to monitor for paging in the grouped paging frames. Being transmitted close to the paging frames may herein be interpreted as being transmitted within a time window, such as within a certain number of system frames from the paging frames. In some exemplary embodiments herein, the reference signals may be considered to be transmitted close to the paging frames when the reference signals are transmitted, for example within X system frames before the first paging frame and/or within Y system frames after the last paging frame in the grouped paging frames. Herein, X may e.g., be four and Y may be two. This may also be referred to as being transmitted within a first number of SSBs before and a second number of SSBs after the paging occasion of the WD. The reference signals may e.g., be considered as being transmitted close to the paging frames when they are transmitted in X SSBs or X/2 SSBs before the paging occasion and/or Y SSBs or Y/2 SSBs after the paging occasion, depending on the periodicity with which the SSBs are transmitted in the cell. Therefore, according to this disclosure, the cells in low activity mode in the wireless communications network may be system frame synchronized. The paging occasions in the cells that are included in the low activity mode may be scheduled so that they occur simultaneously in the different cells, such as in the serving cell of a WD and in one or more neighbor cells. Thereby the WDs can measure on its own cell and on all neighbor cells simultaneously and the radio network node does not need to be active (such as transmitting or receiving) outside the periods in which the paging occasions are scheduled. Neighbor radio network nodes may also save power when WD measurements are aligned, since the reference signal transmissions may be synchronized. In the low activity mode, the radio network node may thus refrain from transmitting reference signals and/or synchronization signals that are not associated with paging occasion of the low activity mode, such as with the second set of paging resources. Thereby, the radio network node may stay inactive for longer durations, which reduces the energy consumption of the radio network node.

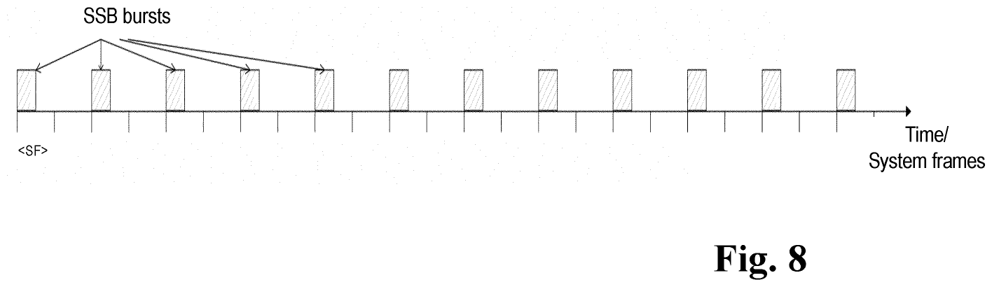

In FIG. 8, a known reference signal transmission, such as an SSB burst comprising reference signals, in NR is shown. The known reference signal transmission may herein also be referred to as a legacy reference signal transmission. Since the first set of paging signals for different WDs may be distributed in time, the radio network node transmits the reference signals with a first periodicity, such as a default periodicity, in order to allow the WDs to synchronize to the radio network node in order to enable the WDs to monitor for paging in their corresponding first set of paging resources. The reference signals may e.g. be transmitted every K subframe in every N system frame, and may thus be considered being continuously transmitted. The reference signals transmitted with the first periodicity and enabling the WDs to monitor the first set of paging resources may herein be referred to as reference signals being transmitted in conjunction with the first set of paging resources. By periodically transmitting SSBs it is ensured that reference signals are always transmitted in a vicinity of paging resources for the WDs, regardless of the respective DRX cycle and/or the location of the paging resource of the WDs. The exact location of the reference signals in relation to the paging resources for the respective WDs may however vary, since the location is determined by the relationship of the periodicity of the reference signal transmission and the respective periodicity of the paging resources (such as the DRX cycle) of the WDs. As can be seen in FIG. 8, the reference signals, such as the SSBs, are transmitted at the beginning of every second system frame, such as in the first five subframes of every second system frame, such as with a 20 ms periodicity. Each SSB may comprise reference signals and synchronization signals used by the WD to perform measurements, to make channel estimations for demodulation and/or to synchronize to the radio network node.

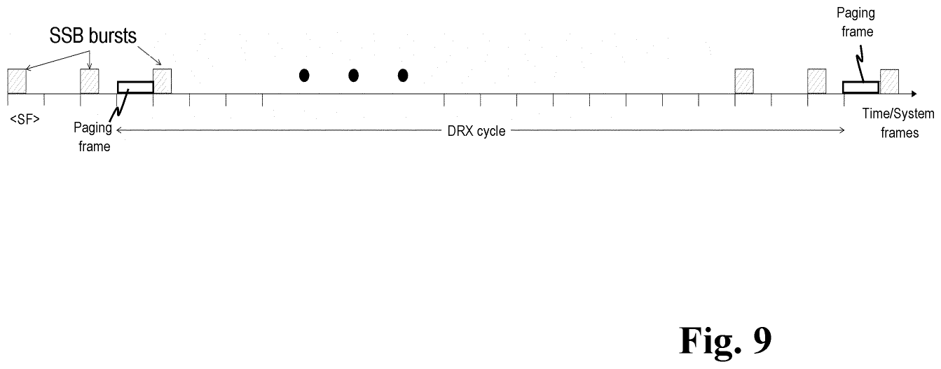

In FIG. 9, a transmission of SSBs comprising reference signals, such as synchronization signals, in a cell during the low activity mode according to this disclosure is shown. As can be seen, the grouped paging frames (where all WDs in the cell are paged and/or where all the WDs monitor for paging) in the cell in low activity mode are shown and corresponding transmitted SSB bursts for synchronization and measurements of WDs in idle mode are given. The WD may use the synchronization signals comprised in the SSBs to synchronize to the radio network node prior to the paging resource, such that it the WD may monitor the correct paging resource for paging. Since no paging signals are transmitted in between the paging frames of the grouped paging resources, there is no need for transmitting reference and/or synchronization signals, such as comprised in the SSB bursts, that are not associated with the grouped paging frames. The base-station may thus not transmit SSBs in conjunction with the first set of paging resources, such as with the periodicity of 20 ms as disclosed in FIG. 8. Instead, the radio network node may cease to transmit reference signals in conjunction with the first set of paging resources. In other words, the radio network node may refrain from transmitting reference signals that are not associated with the grouped paging frames, such as with the paging occasions of the second set of paging resources.

It shall be noted that the solution according to this disclosure may not affect the S-TMSI, 5G-S-TMSI and similar IDs, such as UE IDs of the WDs, these will be used to identify the WD in the paging events and for other functionality using these IDs in the wireless communications network. The alternative or temporary WD ID may only be used by the WDs for determining the second set of paging resources.

To ensure mobility of the WDs, a planning of in which cells this is activated should be done with care. Different areas with respect to cell or WD activities may be defined. In an area, where we refer to as first area, there are only a few WDs in the neighborhood in many cells. These cells may apply the low activity mode, such as limiting the reference signal transmissions (such as refraining from transmitting reference and/or synchronization signals that are not associated with the grouped paging frames) and grouping the DRX events (such as the paging frames) to be grouped to same or adjacent DRX cycles. In the border of the first area, where the number of UEs becomes larger, but still manageable, an area between the cells in low activity mode and the cells in normal mode, which may herein also be referred to as a second area, needs to be planned. In the second area, the paging frames defined by the low activity mode may be used, so that the WDs can measure on neighbor cells in low activity mode when the reference signals are transmitted. All reference and/or synchronization signals may be transmitted in the cells in the second area, in order for a WD from an outside area moving into the low activity area can perform measurements on these cells. In other words, in the cells in the second area, reference and/or synchronization signals may be transmitted with the default periodicity, such as the 20 ms as shown in FIG. 8.

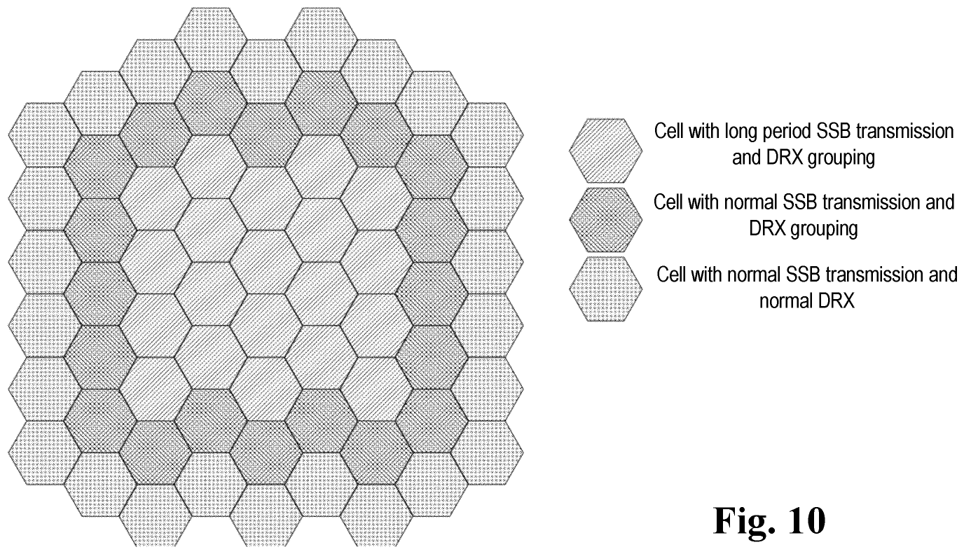

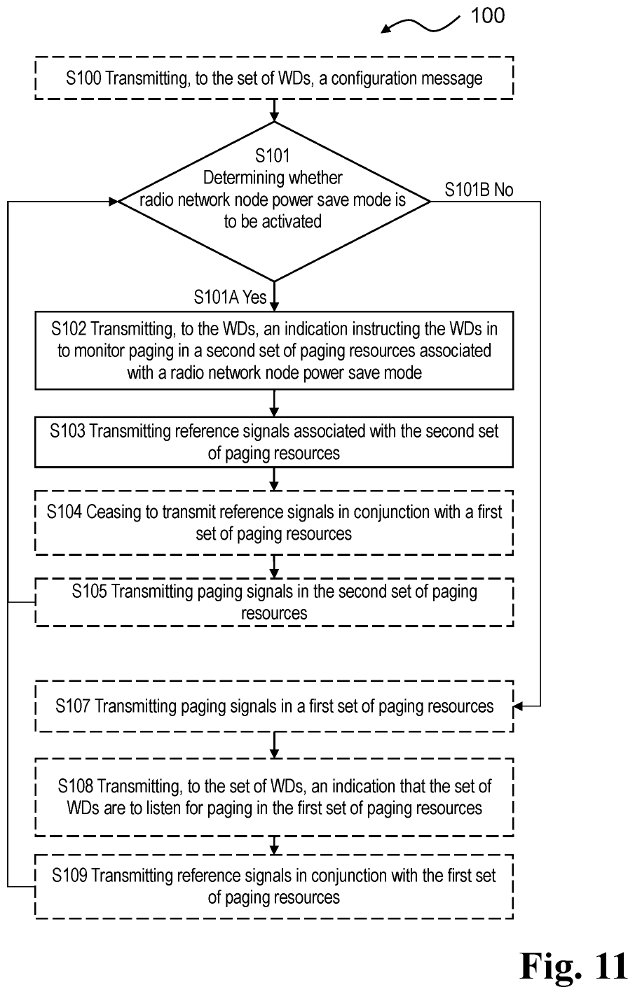

FIG. 10 illustrates a cell planning of cells in low activity mode, such as cells of a radio network node that has activated the radio network node power save mode, according to this disclosure. In a first area, such as a center area, there may be cells in low activity mode, using only a few grouped DRX cycles. Around these cells in a second area, there are cells that may also use grouping of paging resources, and/or DRX cycles, so that WDs may make valid measurements on the low activity cells. The cells in the second area may however transmit all reference signals, such as transmit reference signals with a default periodicity as shown in FIG. 8, in order for WDs in normally configured cells, such as cells in a third area surrounding the second area, to measure on the cells in the second area.

WDs that perform initial cell search, after starting the WD or after the WD exiting flight mode, will likely not find the cells that are in low activity mode since the duty cycle of these cells is very low. If the WD knows that the cell exists, since it was camping on the cell when it was switched off, and assumes that it may be in low activity mode, it may wait a predetermined period of time, such as some seconds, to cover the typical DRX cycles to be able to detect the reference and/or synchronization signals of the cell. The wireless communications network may also use cell planning so that there is coverage on some frequencies or on some cells on the same frequency so that a UE is always able to find cells in the wireless communications network. There being coverage shall herein be understood as reference and/or synchronization signals being transmitted with the default periodicity and with a power allowing WDs in an entire area to find and read broadcasted messages from one or more cells covering the area. After the WD located in the area has registered to a cell in the area, the WD may receive an indication, for example via a broadcasted message, indicating that a power save mode, such as a radio network node power save mode, is available and a configuration of the power save mode enabling the WD to connect to a suitable cell for the power save mode. However, it does not have to be coverage continuously from all cells on all frequencies.

In one or more exemplary solutions for cell planning, two frequency layers may be used. One frequency layer may be used for cells in low activity mode, while the other frequency layer may be used for cells in normal mode transmitting in normal mode, such as without grouping of paging resources and transmitting reference signals with default periodicity. The frequency layer used for cells in normal mode ensures that takes care of the coverage.

In one or more exemplary solutions for cell planning, one independent frequency layer may be used, where a few base stations out of a set of base stations may take care of some coverage for mobility into the area of low activity cells, by transmitting paging signals and reference signals in the normal mode, such as not in low activity mode, and may transmit the temporary WD ID to be used by WD wanting to enter the area of low activity cells.

FIG. 11 shows a flow diagram of an exemplary method 100, performed in a radio network node, for power management in a wireless communications network according to the disclosure. The radio network node is transmitting reference signals to WDs (such as one or more WDs) in conjunction with the first set of paging resources that the WDs are monitoring for paging. The first set of paging resources may herein also be referred to as legacy paging resources, and may be configured based on a WD identifier, such as a UE ID, of the WDs. The reference signals transmitted in conjunction with the first set of paging resources may herein be understood as that these signals are relatively close in time and frequency. In other words, the reference signals are scheduled such that they are enabling WDs to periodically measure on and synchronize to the radio network node in order to monitor paging in the first set of paging resources.

For example, the reference signals may be transmitted periodically, or at least substantially periodically, so that a reference signal is always transmitted in a vicinity (in time and/or frequency) of a paging resource in the first set of paging resources, regardless of the location of the paging resource, in order to allow the WDs to measure and synchronize to the radio network node prior to a paging resource. The reference signals transmitted in conjunction with the first set of paging resources corresponds to the legacy reference signal transmission described in relation to FIG. 8.

The method 100 comprises, upon determining that a radio network node power save mode is to be activated, transmitting S102, to the WDs, an indication instructing the WDs to monitor paging in a second set of paging resources associated with the radio network node power save mode. The indication transmitted may inform the WDs that they will be paged in the second set of paging resources when the radio network node receives, for example from a core network node, a paging request for one or more of the WDs. The method 100 further comprises, transmitting S103 reference signals to the WDs associated with the second set of paging resources that the WDs are instructed to monitor for paging. The second set of paging resources may, in one or more example methods, be configured based on a WD identifier, such as the UE ID of the WD and/or a temporary WD identifier, such as a temporary UE ID, of the WD.

The reference signals may herein be considered associated with the second set of paging resources when they are required by the WD for monitoring the second set of paging resources for paging, or at least when they enable the WD to monitor the second set of paging resources for paging. This may for example be synchronization signals enabling the WD to synchronize to the radio network node prior to the second set of paging resources, such as prior to a paging frame of the second set of paging resources. The reference signals associated with the second set of paging resources may be reference signals that are transmitted within a number of system frames, for example four system frames, before the paging resource and/or within a number of system frames, e.g. two system frames, after the paging resource. In other words, one or more SSBs associated with, such as comprising the reference signals associated with, the second set of paging resources may be transmitted by the radio network node.

While the reference signals transmitted in conjunction with the first set of paging resources are uncoordinatedly transmitted in conjunction with the first set of paging resources, such as due to the periodicity of the reference signal transmission, the reference signals transmitted in association with the second set of paging occasions are, in one or more example methods, actively selected to be transmitted in the vicinity of the second set of paging resources. Uncoordinatedly herein refers to that there is no specific coordination between the reference signals and the first set of paging resources. In association with herein refers to that the time between the reference signal and the paging resource is considered and/or known by the radio network node.

In some embodiments, two signals are associated if the radio network node is aware that a reference signal is required and that it has taken that into account when scheduling the signal. In some embodiments, in association means that the resources for transmitting the signals are determined in coordination with, such as based on, the second set of paging resources for transmitting paging signals. For example, when the radio network node has grouped the paging resources for the WDs into the second set of paging resources, the radio network node may cease to transmit reference signals with the default periodicity and may transmit reference signals only in the vicinity of the second set of paging resources. Hence, in this example the radio network node determines, based on the location of the second set of paging resources, where to transmit the reference signals enabling the WDs to monitor the second set of paging resource.

Since the reference signals are determined to be transmitted based on the location of the second set of paging resources, they may be referred to as being associated with the second set of paging resources. In some embodiments, the reference signals transmitted in association with the second set of paging resources may be a subset of the reference signals transmitted in conjunction with the first set of paging resources. The radio network node may for example determine to only transmit the reference signals out of the reference signals transmitted in conjunction with the first set of paging resources that are scheduled within a certain time period from the second set of paging resources.

The second set of paging resources may at least be partly different from the first set of paging resources. In one or more exemplary methods, the second set of paging resources may be grouped in one single resource or in a plurality of adjacent resources in the time domain. The resources may for example be system frames or slots. In one or more exemplary methods, the second set of paging resources may be arranged in a same bandwidth part, such as in a same frequency range, such as in a same frequency band. In one or more exemplary methods, the second set of paging resources may be arranged in different bandwidth parts, such as in different frequencies within a frequency band, frequency ranges or frequency bands.

The indication may be transmitted to the WDs via broadcast or via unicast transmission. The indication may in one or more examples be an operation flag in a system operation, indicating that the base station intends to enter the power save mode, such as a low activity mode.

In one or more exemplary methods, the second set of paging resources may be pre-configured. and the indication transmitted to the WDs may comprise a flag indicating that the WDs are to listen to paging in the second set of paging resources. The second set of resources being pre-configured may comprise the second set of paging resources being hardcoded in the WDs and/or pre-agreed between the radio network node and the WDs.

In one or more exemplary methods, the indication may be indicative of a time and/or frequency location of the second set of paging resources. The time and/or frequency location of the second set of paging resources may implicitly or explicitly indicated. The implicit indication may for example be an indication that the radio network node is entering the radio network node power save mode. The WDs may be preconfigured with the time and/or frequency locations of the second set of paging resources and may be configured to listen for paging signals in the preconfigured time and/or frequency locations of the second set of paging resources upon receiving the indication that the radio network node enters the power save mode. The radio network node may in some embodiments herein explicitly indicate the time and/or frequency locations by indicating the bandwidth part, such as a frequency band, and/or specific time, such as a specific subframe, in which the WDs are to listen to paging signals.

In one or more exemplary methods, the indication may be indicative of a time, such as a time period, that the power save mode is to be activated. The radio network node may indicate to the WDs that the radio network node is to be in the power save mode for a certain time period. Once the time period has expired, the WDs may return to listening for paging signals in the first set of paging resources. The WDs may be preconfigured to listen for paging signals in the first set of paging resources once the time period has expired. In some embodiments herein, the indication sent from the radio network node may further indicate to the WDs that the WDs are to return to listening for paging signals in the first set of paging resources once the time period has expired.

In one or more exemplary methods, the method may comprise transmitting S100, to the WDs, a configuration message, such as an RRC message, comprising one or more parameters enabling the WD to determine the resources of the second set of paging resources. The one or more parameters enabling the WD to determine the resources of the second set of paging resources may comprise a temporary WD ID, a parameter modifying an equation for determining the paging resources in time based on the WD ID, and/or other bandwidth part(s), such as a second bandwidth part, a third bandwidth part and/or an n^{th} bandwidth part, in which the WDs are to listen for paging signals. The second bandwidth part in which the WDs are to monitor paging signals may for example be determined as a function of the temporary WD ID, such as the temporary UE ID. By transmitting parameters indicating the same or adjacent paging resources to be monitored, the paging resources for the WDs may be grouped in time or frequency.

In one or more exemplary methods, the one or more parameters enabling the WD to determine the resources of the second set of paging resources may comprise a temporary WD ID, such as a temporary UE ID, enabling the WDs to calculate the second set of paging resources, such as paging frames and paging occasions, based on the equations (1) and/or (2) shown above.

In one or more exemplary methods, the one or more parameters enabling the WD to determine the resources of the second set of paging resources may comprise a parameter indicating the number of frames N_{low activity} out of the T possible frames that are available for paging resources during the radio network node power save mode. The modified equation may be the known equation (1), for determining the paging frames, taken modulo N_{low activity}, such that the modified equation corresponds to equation (3) above. In one or more exemplary methods the one or more parameters may indicate a second bandwidth part, such as a second frequency range, in which the second set of paging resources are located, as described in relation to FIG. 6.

In one or more exemplary methods, the method may comprise determining S101 whether the radio network node power save mode is to be activated. The radio network node may determine whether the radio network node power save mode is to be activated based on an activity threshold. For example, determining S101 whether the radio network node power save mode is to be activated comprises determining whether an activity in a cell served by the radio network node is below an activity threshold. For example, it may be determined that the radio network node power save mode is to be activated when the activity in a cell served by the radio network node is below the activity threshold. The activity threshold may be a predetermined number of WDs in connected mode or a predetermined number of pagings that have to be transmitted in the cell.

In one or more exemplary methods, the method may comprise, in response to the determining S101A that the radio network node power save mode is activated (for example when the activity in the cell served by the radio network node is below the activity threshold), ceasing S104 to transmit reference signals, such as synchronization signals, in conjunction with the first set of paging resources.

The radio network node may initially be configured to transmit paging signals to, which may also be referred to as page, the WDs in the first set of paging resources. The step of ceasing 104 to transmit reference signals in conjunction with the first set of paging resources may comprise re-configuring the radio network node to transmit paging signals to the WDs in the second set of paging resources. It shall be noted that, although the radio network node is configured to transmit paging signals in a set of paging resources, paging signals may only be transmitted by the radio network node in the paging resources when the radio network node has received a paging request, for example from a core network node, for one or more WDs. However, in order to synchronize the WDs to the radio network node, such as the SFN counters of the WD and the radio network node, so that the WD monitors the correct paging resources, the radio network node may transmit reference signals, such as synchronization signals, associated with each of the paging resources that it is configured to transmit paging in. Hence, when ceasing 104 to transmit reference signals in conjunction with the first set of paging resources, the WD may reconfigure itself to transmit paging signals in the second set of paging resources and may transmit reference signals associated with the configured second set of paging resources. In other words, the step of ceasing to transmit reference signals in conjunction with the first set of paging resources may comprise refraining from transmitting reference signals, such as synchronization signals, that are not associated with the second set of paging resources. Thus, transmission of reference signals, which may be transmitted in SSB bursts with the first periodicity, such as 20 ms periodicity, in the legacy solution, may be aligned with the second set of paging resources. By refraining from transmitting reference signals that are not associated with the second set of paging resources, the time periods in which the radio network node may be inactive is increased. This corresponds to the exemplary embodiment shown in relation to FIG. 9 above.

In one or more exemplary methods, the method may comprise transmitting S105 paging signals to the WDs in the second set of paging resources. The radio network node thus only has to wake up to send paging signals in the second set of paging resources which are grouped to the same or adjacent resources in time.

In one or more exemplary methods, the method may comprise, upon determining S101B that the radio network node power save mode is not to be activated (for example when the activity in a cell served by the radio network node is above the activity threshold), transmitting S107, to the WDs, reference signals in conjunction with the first set of paging resources. Not to be inactivated may herein also be interpreted as the radio network node power save mode being deactivated and/or the normal mode being activated.

In one or more exemplary methods, the method may comprise, upon determining S101B that the radio network node power save mode is not to be activated (for example when the activity in a cell served by the radio network node is above the activity threshold), transmitting S108, to the WDs, an indication instructing the WDs to monitor paging in the first set of paging resources. The indication transmitted may inform the WDs that the radio network node will page them, such as transmit paging signals, in the first set of paging resources when the radio network node receives a paging request for one or more of the WDs. In one or more exemplary methods, the indication transmitted to the set of WDs may comprise a flag indicating that the radio network node power save mode is deactivated and that the first set of paging resources are located in pre-configured resources, such as in the legacy resources determined based on the WD ID, such as the UE ID, of the WDs.

In one or more exemplary methods, the method may comprise, in response to the determining S101B that the radio network node power save mode is not to be activated, transmitting S109 reference signals, such as synchronization signals, in conjunction with the first set of paging resources. The step of transmitting 109 reference signals in conjunction with the first set of paging resources may comprise re-configuring the radio network node to transmit paging signals to the WDs in the first set of paging resources and/or to transmit reference signals in conjunction with the first set of paging resources. In order for the WDs to measure on and synchronize to the radio network node prior to monitoring paging in the first set of paging resources, the radio network node may resume transmission of reference signals in conjunction with the first set of paging resources, such as resume transmission of reference signals with the first periodicity, upon returning to the normal mode after having been in the radio network node power save mode.

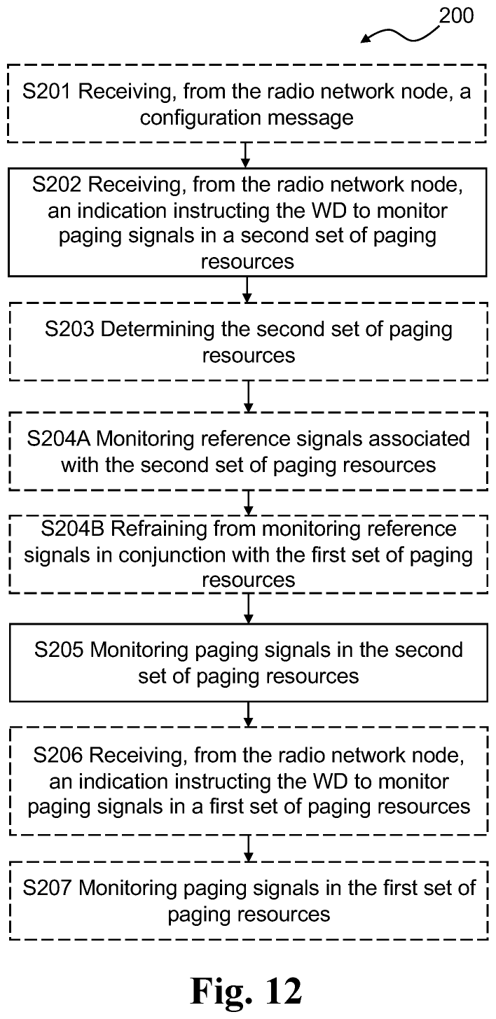

FIG. 12 shows a flow diagram of an exemplary method 200, performed in a WD, for power management in a wireless communications network according to the disclosure. The WD may be comprised in a set of WDs associated to a cell of the radio network node, the WD being configured to listen for paging signals in a first set of paging resources. The first set of paging resources may be configured based on a WD identifier, such as a UE ID, of the WD. The first set of paging resources may herein also be referred to as legacy paging resources. The method 200 comprises receiving S202, from the radio network node, an indication instructing the WD to monitor paging signals at a second set of paging resources associated with a network node power save mode. The method further comprises monitoring S205 paging signals in the second set of paging resources. The second set of paging resources may be at least partly different from the first set of paging resources. In one or more exemplary methods, the second set of paging resources may be pre-configured, such as being hardcoded or pre-agreed. The indication received from the radio network node may comprise a flag indicating that the radio network node power save mode is activated and that the WD is to listen to paging in the second set of paging resources. When the WD receives the flag indicating that the radio network node power save mode is activated the WD may know, for example by being preconfigured, that it should listen for paging signals in the second set of paging resources. The WDs may, upon receiving the flag indicating that the radio network node power save mode is activated, determine the second set of paging resources based on the one or more parameters received S201 in the configuration message.

In one or more exemplary methods, the method may comprise receiving S201, from the radio network node, a configuration message comprising one or more parameters for determining the second set of paging resources. The one or more parameters for determining the second set of paging resources may in one or more example methods be one or more parameters for determining the second set of paging resources based on a WD identifier. The one or more parameters for determining the second set of paging resources may comprise a temporary WD ID, a parameter modifying an equation for determining the paging resources based on the WD ID, and/or a second bandwidth part in which the WDs are to listen for paging signals. When the one or more parameters for determining the second set of paging resources comprises the temporary WD ID, the second set of paging resources for each WD and/or WD group may be determined based on the legacy equations for determining the paging resources. When the one or more parameters for determining the second set of paging resources comprise, the parameter modifying an equation for determining the paging resources based on the WD ID, the second set of paging resources for each WD and/or WD group may be determined based on the legacy WD ID, such as the UE_ID, using the modified equation for determining the paging resources. In other words, the second set of paging resources may, in one or more example methods, be determined based on a WD identifier, such as a temporary WD ID or a legacy WD ID, such as the UE_ID. The second set of paging resources for the WDs, such as for one or more WD paging groups, may be selected so that the second set of paging resources are moved closer together in time while ensuring that at least a first WD and a second WD, such as a first WD comprised in the first WD paging group and a second WD comprised in the second WD paging group, can be separately paged. The one or more parameters for determining the second set of paging resources may be broadcasted or transmitted by dedicated signaling to the WDs when the cell enters low activity mode, such as when the radio network node enters the radio network node power save mode. In a similar way, the WDs may be configured to use its legacy WD ID, such as its legacy UE_ID, when the radio network node deactivates the power save mode and activates, which may also be referred to as enters, the normal mode. The normal mode may herein also be referred to as legacy mode.

In one or more exemplary methods, the one or more parameters for determining the second set of paging resources comprise a temporary WD ID, such as a temporary UE ID, enabling the WDs to determine the second set of paging resources, such as paging frames and paging occasions, based on the equations (1) and/or (2) shown above.

In one or more exemplary methods, the one or more parameters for determining the second set of paging resources comprise a parameter indicating the number of frames N_{low activity} out of the T possible frames that are available for paging resources during the radio network node power save mode. The modified equation may in one or more example methods be the known equation (1), for determining the paging frames, taken modulo N_{low activity}, such that the modified equation corresponds to equation (3) above. In one or more exemplary methods the one or more parameters may indicate a second bandwidth part, such as a second frequency range, in which the second set of paging resources are located. Different WDs may have paging resources in different bandwidth parts. Thereby, the radio network node may page a higher number of WDs in parallel within a limited time, if paging requests are available for the WDs.

In one or more exemplary methods, the method may comprise determining S203 the second set of paging resources based on the parameters in the received configuration message. The WD may for example use the temporary WD ID, such as the temporary UE ID the equations (1) and (2) above, to determine, such as calculate, the second set of paging resources.

In one or more exemplary methods, the WD may be a first WD, and the second set of paging resources for the first WD may be grouped with a second set of paging resources for one or more second WDs having a different first set of paging resources than the first WD. The first WD may in one or more examples be comprised in a first paging group sharing a first set of paging resources. The one or more second WDs may be comprised in a second paging group having a different first set of paging resources than the first paging group. The first and the second paging groups may have different DRX cycles or may have DRX cycles that are offset from each other in time for the first set of paging resources. The DRX cycle for the second paging group may in one or more examples start in a different system frame than the DRX cycle for the first paging group. The second set of paging resources for the first and second paging groups may thus be grouped by aligning the DRX cycles for the first and second paging groups, such that first paging frame in the DRX cycles for the first and the second paging groups are located in the same system frame or adjacent system frames. The first and second paging groups may keep their DRX cycles when the radio network node enters the power save mode, such as when the WDs are configured to listen for paging signals in the second set of paging resources. In other words, one or more first WD may be associated with a first paging group, wherein WDs in the first paging group have the same initial paging occasions in the first set of paging resources (determined based on the WD identity, such as the UE ID, of each WD). The one or more second WDs may be WDs associated with a second paging group having the same initial paging occasions, such as initial paging frames, (determined based on UE ID), which initial paging occasions are different than the initial paging occasions for the first paging group. In the radio network node power save mode, the second set of paging occasions, such as a second set of paging resources, for the WD in the first paging group is, in one or more example methods, grouped with a second set of paging occasions, such as a second set of paging resources, for the one or more WDs in the second paging group.

The second set of paging occasions for the one or more WDs in the first paging group being grouped with a second set of paging occasions for the one or more WDs in the second paging group may herein mean that the paging occasions are moved closer in time domain, but can still be separately paged.

The second set of paging occasions for the one or more WDs in the first paging group being grouped with a second set of paging occasions for the one or more WDs in the second paging group, may herein mean that the paging occasions for the first and the second paging groups may be grouped in one single resource in the time domain and in different resources in the frequency domain, such as according to the example shown in FIG. 6.

The second set of paging occasions for the one or more WDs in the first paging group being grouped with a second set of paging occasions for the one or more WDs in the second paging group, may herein mean that the paging occasions for the first and the second paging groups may be arranged in adjacent resources in the time domain and in the same resource in the frequency domain, such as according to the grouping example shown in FIG. 5.

The second set of paging occasions for the one or more WDs in the first paging group being grouped with a second set of paging occasions for the one or more WDs in the second paging group, may herein mean that the paging occasions for the first and the second paging groups may be arranged in adjacent resources in the time domain and in different resources in the frequency domain, such as according to a combination of the example shown in FIG. 6 and the grouping example shown in FIG. 5.

The second set of paging occasions for the one or more WDs in the first paging group being grouped with a second set of paging occasions for the one or more WDs in the second paging group, does not mean that the paging occasions for the first and the second paging groups may be grouped in one single resource in the time domain and in one single resource in the frequency domain.

In one or more exemplary methods, the indication received from the radio network node may be indicative of a time and/or a frequency location of the second set of paging occasions. In some exemplary methods the second paging resource for the WD may be moved in time and frequency, such that the second set of paging resources are located in a different bandwidth part than the first set of paging resources. The time and/or frequency location of the second set of paging resources may be implicitly or explicitly indicated. The implicit indication may for example be an indication that the radio network node is entering the radio network node power save mode. The WDs may be preconfigured with the time and/or frequency locations of the second set of paging resources and may be configured to monitor paging signals in the preconfigured time and/or frequency locations of the second set of paging resources upon receiving the indication that the radio network node enters the power save mode. The radio network node may in some embodiments herein explicitly indicate the time and/or frequency locations by indicating the bandwidth part, such as a frequency band, and/or specific time, such as a specific subframe, in which the WDs are to monitor paging signals.

In one or more exemplary methods, the indication may be indicative of a time, such as a time period, that the power save mode is to be activated. The radio network node may for example indicate to the WDs that the radio network node is to be in the power save mode for a certain time period. Once the time period has expired, the WDs may return to monitoring paging signals in the first set of paging resources. The WDs may be preconfigured to monitor paging signals in the first set of paging resources once the time period has expired. In some embodiments herein, the indication sent from the radio network node may further indicate to the WDs that the WDs are to return to listening for paging signals in the first set of paging resources once the time period has expired.

Initially, when the WD is monitoring paging signals in the first set of paging resources, the WD may also monitor reference signals in conjunction with the first set of paging resources. The WDs may for example use the reference signals transmitted in conjunction with the first set of paging resources to synchronize to the radio network node prior to monitoring paging signals in the first set of paging resources. In one or more exemplary methods herein, the method may further comprise monitoring S204A reference signals, such as synchronization signals, from the radio network node, which reference signals are associated with the second set of paging resources. By monitoring the reference signals from the radio network node associated with the second set of paging resources, the WD may for example synchronize to the radio network node, such as synchronize the SFN counters of the WD and the radio network node, thereby enabling the WD (or a plurality of WDs) to monitor the correct paging resources, such as the second set of paging resources. The method may further comprise refraining S204B from monitoring reference signals, such as synchronization signals, in conjunction with the first set of paging resources.

In one or more exemplary methods, the method may comprise receiving S206, from the radio network node, an indication that the WD is to listen for paging signals in the first set of paging resources. The WD may for example receive the indication that the WD is to listen for paging signals in the first set of paging resources when the radio network node has determined that the radio network node power save mode is not to be activated, such as when the activity in the cell is above the activity threshold, such as when the radio network node has determined that the activity in the cell is above the activity threshold. In one or more exemplary methods, the indication received from the radio network node may comprise a flag indicating that the radio network node power save mode is deactivated and that the first set of paging occasions are located in pre-configured resources, such as in the resources determined based on the WD identifier, such as the UE ID, such as the legacy UE ID.

In one or more exemplary methods, the method may comprise listening S207 for paging signals in the first set of paging resources. In other words, the WD returns to its original, which may also be referred to as legacy, paging resources, such that the paging occasions for the first and the second paging groups are no longer grouped.

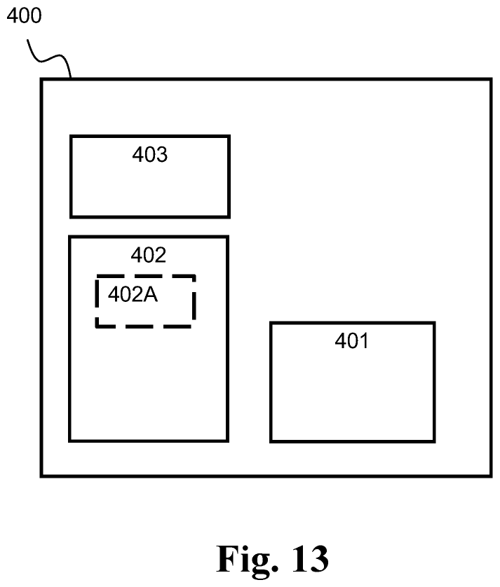

FIG. 13 shows a block diagram of an exemplary radio network node 400 according to the disclosure. The radio network node 400 comprises a memory circuitry 401, a processor circuitry 402, and a wireless interface 403. The radio network node 400 may be configured to perform any of the methods disclosed in FIG. 10. In other words, the radio network node 400 may be configured for power management in a wireless communications network. The radio network node 400 is transmitting synchronization signals to WDs in conjunction with a first set of paging resources that the WDs are monitoring for paging.

The radio network node 400 is configured to communicate with a wireless device, such as a user equipment, such as the user equipment disclosed herein, using a wireless communication system.

The wireless interface 403 is configured for wireless communications via a wireless communication system, such as a 3GPP system, such as a 3GPP system supporting New Radio, NR.

The radio network node 400 is configured to transmit, for example via the wireless interface 403, to the WDs, an indication instructing the WDs to monitor paging in a second set of paging resources associated with the radio network node power save mode upon determining that a radio network node power save mode is to be activated. This may be seen in step S102 of FIG. 10. The second set of paging resources may be at least partly different from the first set of paging resources.

The radio network node 400 is configured to transmit, for example via the wireless interface 403, reference signals, such as synchronization signals, to the WDs associated with the second set of paging resources that the WDs are instructed to monitor for paging.

The first set of paging resources may be configured based on a WD identifier.

The second set of paging resources may be pre-configured and the indication transmitted to the WDs may comprise a flag indicating that the WD is to monitor paging in the second set of paging resources.

The indication may be indicative of a time/frequency location of the second set of paging resources.

The indication may be indicative of a time that the power save mode is to be activated.

The processor circuitry 402 is optionally configured to perform any of the operations disclosed in FIG. 11 (such as any one or more of S100, S103, S101, S101A, S101B, S104, S105, S107, S108, S109). The operations of the network node 400 may be embodied in the form of executable logic routines (e.g., lines of code, software programs, etc.) that are stored on a non-transitory computer readable medium (e.g., the memory circuitry 401) and are executed by the processor circuitry 402).

Furthermore, the operations of the radio network node 400 may be considered a method that the radio network node 400 is configured to carry out. Also, while the described functions and operations may be implemented in software, such functionality may as well be carried out via dedicated hardware or firmware, or some combination of hardware, firmware and/or software.

The memory circuitry 401 may be one or more of a buffer, a flash memory, a hard drive, a removable media, a volatile memory, a non-volatile memory, a random access memory (RAM), or other suitable device. In a typical arrangement, the memory circuitry 401 may include a non-volatile memory for long term data storage and a volatile memory that functions as system memory for the processor circuitry 402. The memory circuitry 401 may exchange data with the processor circuitry 402 over a data bus. Control lines and an address bus between the memory circuitry 401 and the processor circuitry 402 also may be present (not shown in FIG. 12). The memory circuitry 401 is considered a non-transitory computer readable medium.

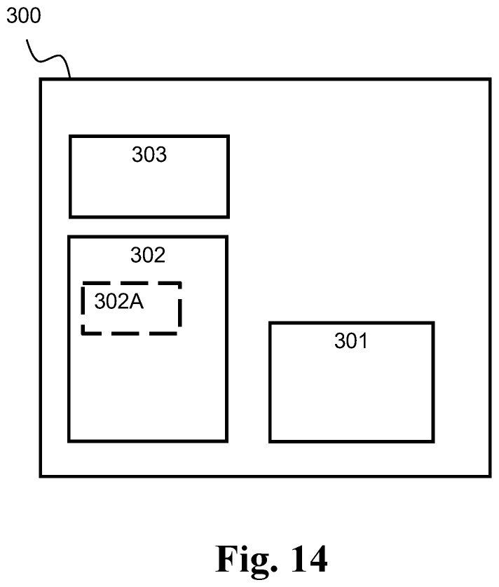

FIG. 14 shows a block diagram of an exemplary wireless device 300 according to the disclosure. The wireless device 300 comprises a memory circuitry 301, a processor circuitry 302, and a wireless interface 303. The wireless device 300, WD, may be configured to perform any of the methods disclosed in FIG. 12. In other words, the wireless device 300 may be configured for power management in a wireless communications network. The WD is comprised in a set of WDs associated to a cell of a radio network node. The WD is configured to monitor paging signals at a first set of paging resources.

The wireless device 300 is configured to communicate with a network node, such as the wireless device disclosed herein, using a wireless communication system.

The wireless device 300 is configured to receive (such as via the wireless interface 303), from the radio network node, an indication instructing the WD to monitor paging signals at a second set of paging resources associated with a network node power save mode. This may be seen in S202 of FIG. 12. The indication may be indicative of a time/frequency location of the second set of paging resources. The indication may be indicative of a time that the power save mode is to be activated for the radio network node.

The wireless device 300 is configured to monitor (such as via the wireless interface 303), for paging signals in the second set of paging resources.

The second set of paging resources may be at least partly different from the first set of paging resources.

The first set of paging resources may be configured based on a WD identifier.

The wireless interface 303 is configured for wireless communications via a wireless communication system, such as a 3GPP system, such as a 3GPP system supporting New Radio, NR.

The wireless device 300 is optionally configured to perform any of the operations disclosed in FIG. 12 (such as any one or more of S201, S203, S204A, S204B, S205, S206, S207). The operations of the wireless device 300 may be embodied in the form of executable logic routines (e.g., lines of code, software programs, etc.) that are stored on a non-transitory computer readable medium (e.g., the memory circuitry 301) and are executed by the processor circuitry 302).

Furthermore, the operations of the wireless device 300 may be considered a method that the wireless device 300 is configured to carry out. Also, while the described functions and operations may be implemented in software, such functionality may as well be carried out via dedicated hardware or firmware, or some combination of hardware, firmware and/or software.

The memory circuitry 301 may be one or more of a buffer, a flash memory, a hard drive, a removable media, a volatile memory, a non-volatile memory, a random access memory (RAM), or other suitable device. In a typical arrangement, the memory circuitry 301 may include a non-volatile memory for long term data storage and a volatile memory that functions as system memory for the processor circuitry 302. The memory circuitry 301 may exchange data with the processor circuitry 302 over a data bus. Control lines and an address bus between the memory circuitry 301 and the processor circuitry 302 also may be present (not shown in FIG. 14). The memory circuitry 301 is considered a non-transitory computer readable medium.

Embodiments of methods and products (radio network node and wireless device) according to the disclosure are set out in the following items:
Item 1. A method, performed in a radio network node, for power management in a wireless communications network, wherein the radio network node is transmitting reference signals to Wireless Devices, WDs, in conjunction with a first set of paging resources that the WDs are monitoring for paging, the method comprising:
   upon determining (S101A) that a radio network node power save mode is to be activated, transmitting (S102), to the WDs, an indication instructing the WDs to monitor paging in a second set of paging resources associated with the radio network node power save mode, wherein the second set of paging resources is determined based on a WD identifier, and
   transmitting (S103), to the WDs, reference signals associated with the second set of paging resources that the WDs are instructed to monitor for paging.
Item 2. The method according to Item 1, wherein the method comprises, in response to the determining (S101A) that the radio network node power save mode is activated:
   ceasing (S104) to transmit reference signals in conjunction with the first set of paging resources.
Item 3. The method according to Item 1 or 2, wherein the second set of paging resources is at least partly different from the first set of paging resources.
Item 4. The method according to any one of the previous Items, wherein the first set of paging resources is configured based on a WD identifier.
Item 5. The method according to any one of the previous Items, wherein the second set of paging resources is pre-configured and wherein the indication transmitted to the WDs comprises a flag indicating that the WD is to listen to paging in the second set of paging resources.
Item 6. The method according any one of the previous Items, wherein the indication is indicative of a time/frequency location of the second set of paging resources.
Item 7. The method according to any one of the previous Items, wherein the indication is indicative of a time that the power save mode is to be activated.
Item 8. The method according to any one of the previous Items, wherein the method comprises:
   transmitting (S100), to the WDs, a configuration message comprising one or more parameters enabling the WD to determine the resources of the second set of paging resources.
Item 9. The method according to Item 8, wherein the one or more parameters are parameters enabling the WD to determine the resources of the second set of paging resources based on the WD identifier.
Item 10. The method according to Item 8 or 9, wherein the one or more parameters comprises a temporary WD identifier.
Item 11. The method according to any one of Items 8 to 10, wherein the one or more parameters comprises a parameter modifying an equation for determining the paging resources based on the WD identifier.
Item 12. The method according to any one of claims 8 to 11, wherein the one or more parameters comprises a second bandwidth part in which the WDs are to listen for paging signals.
Item 13. The method according to any one of the previous Items, wherein the method comprises:
   transmitting (S105) paging signals to the WDs in the second set of paging resources.
Item 14. The method according to any one of the previous Items, wherein the method comprises:
   determining (S101) whether the radio network node power save mode is to be activated based on an activity threshold.
Item 15. The method according to any one of the previous Items, wherein the method comprises:
   upon determining (S101B) that the radio network node power save mode is not to be activated, transmitting (S107), to the WDs, an indication instructing the WDs to monitor paging in the first set of paging resources, and
   transmitting (S108), to the WDs, reference signals in conjunction with the first set of paging resources.
Item 16. The method according to Item 15, wherein the indication transmitted to the set of WDs comprises a flag indicating that the radio network node power save mode is deactivated and that the first set of paging resources are located in pre-configured resources.
Item 17. The method according to any one of the previous Items, wherein the second set of paging resources are grouped in one single resource or in a plurality of adjacent resources in the time domain.
Item 18. The method according to Item 17, wherein the second set of paging resources are arranged in a same bandwidth part.
Item 19. The method according to any one of the Items 17 to 18, wherein the second set of paging resources are arranged in different bandwidth parts.
Item 20. The method according to any one of the previous Items, wherein the ceasing (S104) comprises, refraining from transmitting reference signals that are not associated with the second set of paging resources.
Item 21. A method performed in a Wireless Device, WD, for power management in a wireless communications network, wherein the WD is comprised in a set of WDs associated to a cell of a radio network node, wherein the WD initially monitors paging signals at a first set of paging resources, the method comprising:
   receiving (S202), from the radio network node, an indication instructing the WD to monitor paging signals at a second set of paging resources associated with a network node power save mode, wherein the second set of paging resources is determined based on a WD identifier, and
   monitoring (S205) paging signals in the second set of paging resources.
Item 22. The method according to Item 21, wherein the second set of paging resources is at least partly different from the first set of paging resources.

Item 23. The method according to any one of the Items 21 to 22, wherein the first set of paging resources is configured based on a WD identifier.
Item 24. The method according to any one of the Items 21 to 23, wherein the method comprises:
   receiving (S201), from the radio network node, a configuration message comprising one or more parameters for determining the second set of paging resources.
Item 25. The method according to claim 24, wherein the one or more parameters are parameters enabling the WD to determine the resources of the second set of paging resources based on the WD identifier.
Item 26. The method according to claim 24 or 25, wherein the one or more parameters comprises a temporary WD identifier.
Item 27. The method according to any one of claims 24 to 26, wherein the one or more parameters comprises a parameter modifying an equation for determining the paging resources based on the WD identifier.
Item 28. The method according to any one of claims 24 to 27, wherein the one or more parameters comprises a second bandwidth part in which the WDs are to listen for paging signals.
Item 29. The method according to Item 24 to 28, wherein the method comprises:
   determining (S203) the second set of paging resources based on the parameters in the received configuration message.
Item 30. The method according to any one of the Items 21 to 29, wherein the method further comprises monitoring (S204A) reference signals associated with the second set of paging resources.
Item 31. The method according to any one of the Items 21 to 30, wherein the method further comprises refraining (S204B) from monitoring reference signals associated with the first set of paging resources.
Item 32. The method according to any one of the Items 21 to 31, wherein the WD is a first WD, and wherein a second set of paging resources for the first WD is grouped with a second set of paging resources for one or more second WDs having a different first set of paging resources than the first WD.
Item 33. The method according to any one of the Items 21 to 32, wherein the second set of paging resources is pre-configured and wherein the indication received from the radio network node comprises a flag indicating that the radio network node power save mode is activated and that the WD is to monitor paging in the second set of paging resources.
Item 34. The method according to any one of the Items 21 to 33, wherein the indication received from the radio network node is indicative of a time/frequency location of the second set of paging occasions.
Item 35. The method according to any one of the Items 21 to 34, wherein the indication is indicative of a time that the power save mode is to be activated.
Item 36. The method according to any one of the Items 21 to 35, wherein the method comprises:
   receiving (S206), from the radio network node, an indication instructing the WD to monitor paging signals at the first set of paging resources, and
   monitoring (S207) paging signals in the first set of paging resources.
Item 37. The method according to Item 36, wherein the indication received from the radio network node comprises a flag indicating that the radio network node power save mode is deactivated and that the first set of paging occasions are located in pre-configured resources.
Item 38. A radio network node comprising a memory circuitry, a processor circuitry, and a wireless interface, wherein the radio network node is configured to perform any of the methods according to any of Items 1-20.

Item 39. A wireless device comprising a memory circuitry, a processor circuitry, and a wireless interface, wherein the wireless device is configured to perform any of the methods according to any of Items 21-37.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-13 comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed in a radio network node, for power management in a wireless communications network, wherein the radio network node is transmitting reference signals to Wireless Devices (WDs) in conjunction with a first set of paging resources that the WDs are monitoring for paging, the method comprising: upon determining that a radio network node power save mode is to be activated, transmitting, to the WDs, an indication instructing the WDs to monitor paging in a second set of paging resources associated with the radio network node power save mode, wherein the second set of paging resources is determined based on a WD identifier, and
transmitting, to the WDs, reference signals associated with the second set of paging resources that the WDs are instructed to monitor for paging.

2. The method according to claim 1, wherein the method comprises, in response to the determining that the radio network node power save mode is activated:
ceasing to transmit reference signals in conjunction with the first set of paging resources.

3. The method according to claim 1, wherein the second set of paging resources is at least partly different from the first set of paging resources.

4. The method according to claim 1, wherein the method comprises:
transmitting, to the WDs, a configuration message comprising one or more parameters enabling the WD to determine the resources of the second set of paging resources.

5. The method according to claim 4, wherein the one or more parameters are parameters enabling the WD to determine the resources of the second set of paging resources based on the WD identifier.

6. The method according to claim 4, wherein the one or more parameters comprises a temporary WD identifier.

7. The method according to claim 4, wherein the one or more parameters comprises a parameter modifying an equation for determining the paging resources based on the WD identifier.

8. The method according to claim 4, wherein the one or more parameters comprises a second bandwidth part in which the WDs are to listen for paging signals.

9. The method according to claim 4, wherein the first set of paging resources is configured based on a WD identifier.

10. The method according to claim 4, wherein the second set of paging resources is pre-configured and wherein the indication transmitted to the WDs comprises a flag indicating that the WD is to listen to paging in the second set of paging resources.

11. The method according to claim 1, wherein the indication is indicative of a time/frequency location of the second set of paging resources.

12. The method according to claim 1, wherein the indication is indicative of a time that the power save mode is to be activated.

13. The method according to claim 1, wherein the method comprises:
transmitting paging signals to the WDs in the second set of paging resources.

14. The method according to claim 1, wherein the method comprises: determining whether the radio network node power save mode is to be activated based on an activity threshold.

15. The method according to claim 1, wherein the method comprises: upon determining that the radio network node power save mode is not to be activated, transmitting, to the WDs, an indication instructing the WDs to monitor paging in the first set of paging resources, and
transmitting, to the WDs, reference signals in conjunction with the first set of paging resources.

16. The method according to claim 15, wherein the indication transmitted to the set of WDs comprises a flag indicating that the radio network node power save mode is deactivated and that the first set of paging resources are located in pre-configured resources.

17. The method according to claim 1, wherein the second set of paging resources are grouped in one single resource or in a plurality of adjacent resources in the time domain.

18. The method according to claim 17, wherein the second set of paging resources are arranged in a same bandwidth part.

19. The method according to claim 17, wherein the second set of paging resources are arranged in different bandwidth parts.

20. (canceled)

21. A method performed in a Wireless Device (WD) for power management in a wireless communications network, wherein the WD is comprised in a set of WDs associated to a cell of a radio network node, wherein the WD initially monitors paging signals at a first set of paging resources, the method comprising: receiving, from the radio network node, an indication instructing the WD to monitor paging signals at a second set of paging resources associated with a network node power save mode, wherein the second set of paging resources is determined based on a WD identifier, and monitoring paging signals in the second set of paging resources.

22-39. (canceled)
